(19) United States
(12) Patent Application Publication
(10) Pub. No.: US 2013/0209675 A1
(43) Pub. Date: Aug. 15, 2013

(54) Method for providing a substrate with luminous material

(71) Applicant: OSRAM GMBH, (US)

(72) Inventor: Martin Reiss, Sinzing (DE)

(73) Assignee: OSRAM GMBH, Muenchen (DE)

(21) Appl. No.: 13/753,643

(22) Filed: Jan. 30, 2013

(30) Foreign Application Priority Data
Feb. 1, 2012 (DE) 102012201448.9

(51) Int. Cl. B05D 5/06

(52) U.S. Cl. CPC B05D 5/06
USPC 427/157

(57) ABSTRACT

A method for producing a plate admixed with phosphor for a remote phosphor light source may include: a) providing a base layer with a first ring-shaped elevation; b) introducing a material admixed with phosphor and having a first predefinable viscosity into the first ring-shaped elevation; and c) curing the material admixed with phosphor in order to produce a first layer admixed with phosphor.

### TECHNICAL FIELD

The invention relates to a method for producing a plate admixed with phosphor for a remote phosphor light source.

### PRIOR ART

Remote phosphor light sources are understood to mean light sources in which the phosphor layer is separated from the actual chip. This separation of the phosphor, which is responsible for the formation of the emitted radiation, makes it possible to achieve a high efficiency, that is to say a high brightness in conjunction with low current consumption.

It is known to produce such plates admixed with phosphor by spin coating, hot pressing, printing or taping.

The production methods known from the prior art have the disadvantage, however, that either an undesirably high waste of the material admixed with phosphor is incurred or the methods are expensive and complex.

### SUMMARY OF THE INVENTION

The object of the present invention is, therefore, to provide a method for producing a plate admixed with phosphor for a remote phosphor light source which can be carried out particularly cost-effectively and in which as little material waste as possible is incurred.

This object is achieved by means of a method comprising the features of patent claim 1.

The present invention is based on the insight that a plate admixed with phosphor can be produced particularly cost-effectively and simply and without waste of material admixed with phosphor when a step a) firstly involves providing a base layer with a first ring-shaped elevation, then a step b) involves introducing a material admixed with phosphor and having a first predefinable viscosity into the first ring-shaped elevation and subsequently a step c) involves curing the material admixed with phosphor in order to produce a first layer admixed with phosphor.

The ring-shaped elevation can furthermore be used for positioning a partition that facilitates the application of the material admixed with phosphor. The partition can also serve as a sealing ring for fitting other parts of a lamp, for example reflectors, sealing material and fixing rings.

The ring-shaped elevation makes it possible to apply the material admixed with phosphor in a very wide viscosity range from very liquid to highly viscous. A very planar surface results in the case of very liquid material, while a convex surface arises in the case of highly viscous material. Predeterminable optical properties can thus be obtained. By virtue of the viscosity of the material admixed with phosphor, the shape of the surface of the layer admixed with phosphor and thus its optical properties can accordingly be set on account of the surface tension. Preferably, for this purpose the ring-shaped elevation has a diameter of from ½ mm to 2 cm. The minimum thickness of the base layer is preferably 200 to 300 μm.

There is no need to use material admixed with phosphor for the first ring-shaped elevation, since the plate admixed with phosphor is normally covered by a reflector or other parts of the lamp. The present invention makes possible a cost saving by allowing the base layer and the first ring-shaped elevation to be provided from a material which is not admixed with phosphor.

In this way, not only is it possible to produce a plate admixed with phosphor without waste of the material admixed with phosphor, but it is also possible to modify the properties of the layer admixed with phosphor as desired with regard to the layer thickness and the type of phosphor in a particularly simple manner.

The base layer provided in step a) is preferably produced in accordance with two different variants: in the first variant, a step a1) involves providing a planar base layer and subsequently a step a2) involves etching a predefinable region of the planar base layer in order to produce a depression surrounded by the first ring-shaped elevation in the base layer. In the second variant, a step a1) involves providing a planar base layer and subsequently a step a2) involves applying a ring on the surface of the planar base layer, which ring constitutes a first ring-shaped elevation.

Both variants make it possible to produce the base layer of the first ring-shaped elevation in a particularly simple and thus cost-effective manner, in particular without waste of the material admixed with phosphor being incurred. The second variant is distinguished by even less material waste than the first variant.

Particularly preferably, the material for the ring-shaped elevation has reflective properties, in particular as a result of doping with metal particles. A particularly high efficiency is obtained in this way since, as a result of this measure, the entire radiation can be fed to the layer admixed with phosphor.

Preferably, the ring is applied in step a2) by mold casting or dispensing.

The material admixed with phosphor is preferably introduced into the first ring-shaped elevation in step b) by dispensing or printing, in particular screen printing.

The following development of the method according to the invention has proved to be particularly advantageous: in this case, a step d) involves providing at least one second or further ring-shaped elevation on the topmost, in particular the first, layer admixed with phosphor. Subsequently, a step e) involves introducing a material admixed with phosphor and having a second or further predefinable viscosity into the second or further ring-shaped elevation. Subsequently, a step f) involves curing the material admixed with phosphor in order to produce a second or further layer admixed with phosphor. In this way, different, mutually independent phosphor layers can be arranged successively one on top of another. Different optical properties of the resulting plate admixed with phosphor can be obtained in this way.

Particularly preferably, a step g) involves applying a protective layer to the topmost layer admixed with phosphor. In this way, sensitive phosphor layers can be protected against moisture or oxidation. Since this can take place directly after the production of the topmost layer admixed with phosphor, the topmost layer admixed with phosphor is already reliably protected against the occurrence of adverse environmental influences.

Said protective layer can also be embodied such that it has optical properties. In this case, the protective layer can preferably be applied by dispensing or printing, in particular screen printing.

Preferably, in this case the protective layer is embodied such that it congruently covers the combination of topmost ring-shaped elevation and topmost layer admixed with phosphor. Maximum protection against moisture and oxidation is provided in this way.

The respective ring-shaped elevation can be, in particular, circular, oval, angular or elliptical. The optical properties of the plate admixed with phosphor can likewise be set through the choice of the shape of the ring-shaped elevation. “Ring-shaped” in the sense of the invention merely means having a closed shape.

The base layer and/or the protective layer can comprise one or more of the following materials: silicone, parylene, epoxy resin, glass, polycarbonate and polyacrylic.

The layer admixed with phosphor can preferably comprise as carrier material one or more of the following materials: silicone, epoxy resin, polyacrylic and polyacrylic-polyurethane copolymer.

One preferred embodiment of the method according to the invention furthermore comprises a step h), which involves introducing scattering materials into the material admixed with phosphor and/or into the material from which the protective layer is formed. By introducing scattering material, it is possible to produce a very homogeneous radiation and thus a high quality of a remote phosphor light source produced with a plate admixed with phosphor according to the invention.

It is furthermore preferably the case that in step i) it is possible to form a lens shape in a layer admixed with phosphor and/or in the protective layer. In this way, the optical properties of the resulting plate admixed with phosphor can be set as desired.

Particularly preferably, the ring-shaped elevation is not admixed with phosphor. This results in a significant material and cost saving.

Further preferred embodiments are evident from the dependent claims.

### BRIEF DESCRIPTION OF THE DRAWING(S)

Exemplary embodiments of the present invention are described in greater detail below with reference to the accompanying drawings, in which:

FIG. 1 shows a schematic illustration of a flow chart of an exemplary embodiment of a method according to the invention;

FIG. 2 shows a schematic illustration of the construction of a plate admixed with phosphor produced by means of the method according to the invention;

FIG. 3 shows a schematic illustration of various steps of an exemplary embodiment of a method according to the invention; and

FIG. 4 shows a schematic illustration of a remote phosphor light source in which a plate admixed with phosphor produced by means of a method according to the invention is used.

### PREFERRED EMBODIMENT OF THE INVENTION

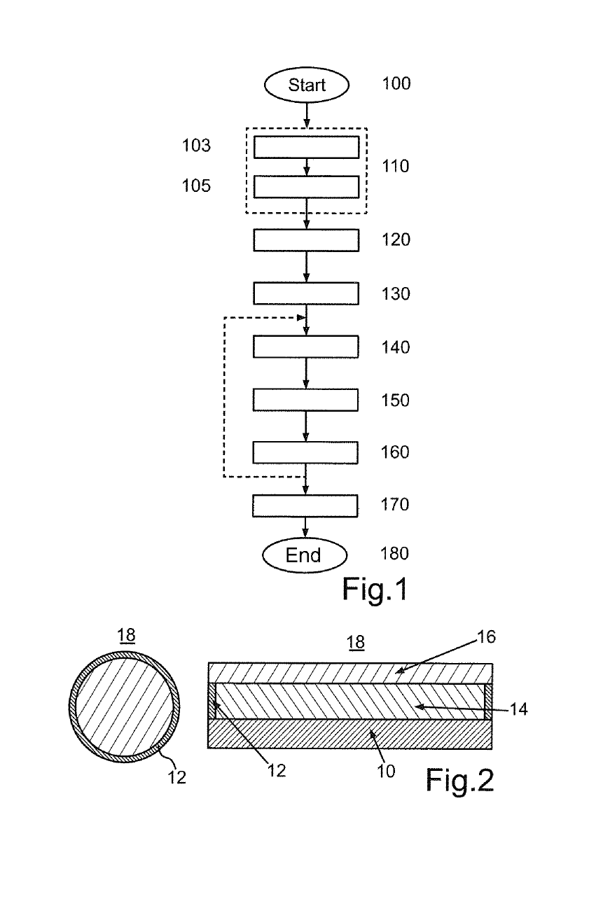

FIG. 1 shows a schematic illustration of a flow chart of an exemplary embodiment of a method according to the invention. The method according to the invention starts in step 100. Firstly, a step 110 involves providing a base layer with a first ring-shaped elevation. This can be effected by two alternatives. In a first variant, firstly step 103 involves providing a planar base layer and subsequently a step 105 involves etching a predefinable region of the planar base layer in order to produce a depression surrounded by the first ring-shaped elevation in the base layer. In the second alternative, firstly a step 103 involves providing a planar base layer and subsequently a step 105 involves applying a ring to the surface of the planar base layer, said ring constituting the first ring-shaped elevation.

Step 120 involves introducing a material admixed with phosphor and having a first predefinable viscosity into the first ring-shaped elevation. Step 130 involves curing the material admixed with phosphor in order to produce a first layer admixed with phosphor. In a step 140, it is possible to provide at least one second or further ring-shaped elevation on the topmost, in particular first, layer admixed with phosphor. In this case, in a step 150, it is possible to introduce a material admixed with phosphor and having a second or further predefinable viscosity into the second or further ring-shaped elevation. Finally, step 160 involves curing the material admixed with phosphor in order to produce a second or further layer admixed with phosphor. Steps 140, 150 and 160 can be repeated in order to produce further layers. In a step 170, it is possible to apply a protective layer to the topmost layer admixed with phosphor. The method ends in step 180.

FIG. 2 shows a schematic illustration of the construction of a plate 18 admixed with phosphor produced by means of the method according to the invention. Said plate comprises a base layer 10, which can comprise, in particular, the materials silicone, parylene, epoxy resin, glass, polycarbonate or polyacrylic. The ring-shaped elevation 12 can be produced from the same materials as the base layer 10. The layer admixed with phosphor is designated by 14, wherein a plurality of such layers can be arranged one above another. It consists, in particular, of silicone, epoxy resin, polyacrylic or polyacrylic-polyurethane copolymer. A protective layer 16 is provided above the combination of layer 14 admixed with phosphor and ring-shaped elevation 12, which protective layer protects in particular the layer 14 admixed with phosphor against oxidation and moisture.

The method according to the invention enables the thickness of the layer admixed with phosphor to be set in a simple manner. The material admixed with phosphor is used very economically; no waste is produced. Simple changes in the design are possible: thus, in particular, convex, concave or planar shapes of the plate admixed with phosphor can be set through a suitable choice of the viscosity of the material admixed with phosphor.

The concentration of the phosphor can be set in a wide range. In this case, the total thickness of the plate admixed with phosphor can likewise be set in a wide range.

In situ mixing of the phosphor paste, that is to say of the material admixed with phosphor, is possible. Therefore, a great variation of types of phosphor is possible; in particular it is possible to use sensitive types with respect to moisture and oxygen, provided that a protective layer 16 is applied after the production of the layer admixed with phosphor.

A large range of polymer materials can be used for the layer admixed with phosphor and the optional protective layer. In particular, different materials for the layer admixed with phosphor and the optional protective layer are also possible.

Optical properties can be introduced into the layer admixed with phosphor and into the optional protective layer.

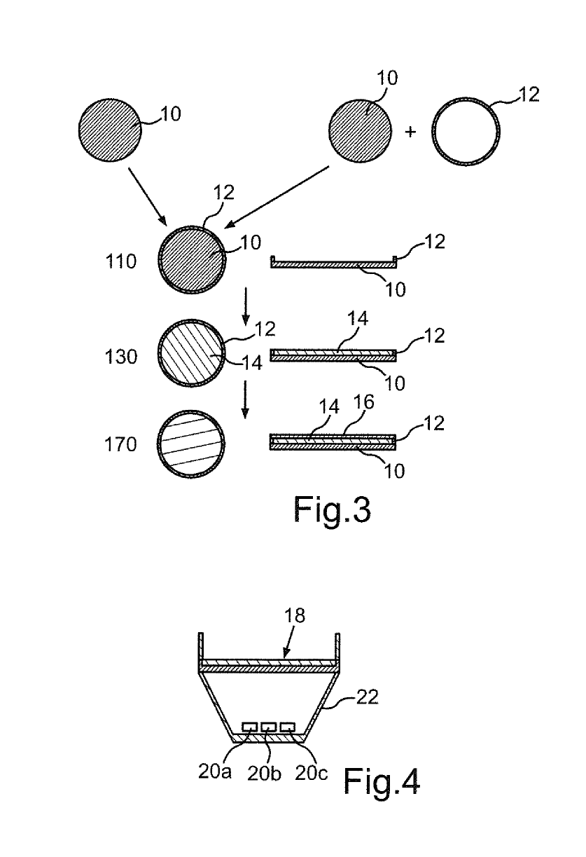

FIG. 3 shows a schematic illustration of two further exemplary embodiments of the method according to the invention. Accordingly, the combination of base layer 10 and ring-shaped elevation 12 is produced either in accordance with steps 103 and 105 according to variant 1 or in accordance with steps 103 and 105 according to variant 2. The result corresponds to step 110 from FIG. 1. This is subsequently followed by steps 120 and 130 and also 170 from FIG. 1, in which the layer 14 admixed with phosphor is introduced into the ring-shaped elevation and cured and a protective layer 16 is applied.

Applying the ring in accordance with variant 2 can be effected by mold casting or dispensing. Introducing the material admixed with phosphor into the ring-shaped elevation and applying the protective layer to the topmost layer admixed with phosphor can be effected by means of dispensing or printing, in particular screen printing.

FIG. 4 shows a schematic illustration of an exemplary embodiment of a remote phosphor light source. In this case, a plurality of LEDs 20a to 20c are fitted to the base of a housing 22. A plate 18 admixed with phosphor, which was produced according to the method according to the invention, is fitted above the LEDs 20a to 20c. The term remote phosphor relates to the aspect that the plate 18 admixed with phosphor is arranged at a certain distance from the LEDs 20a to 20c. A reflector is preferably provided on the inner side of the housing 22 or the inner sides of the housing are embodied in a reflective fashion.

1. A method for producing a plate admixed with phosphor for a remote phosphor light source, the method comprising
a) providing a base layer with a first ring-shaped elevation;
b) introducing a material admixed with phosphor and having a first predefinable viscosity into the first ring-shaped elevation; and
c) curing the material admixed with phosphor in order to produce a first layer admixed with phosphor.

2. The method as claimed in claim 1, wherein the first ring-shaped elevation is produced in a) by means of the following:
a1) providing a planar base layer;
a2) etching a predefinable region of the planar base layer in order to produce a depression surrounded by the first ring-shaped elevation in the base layer.

3. The method as claimed in claim 1, wherein the first ring-shaped elevation is produced in a) by means of the following:
a1) providing a planar base layer;
a2) applying a ring, which constitutes the first ring-shaped elevation, on the surface of the planar base layer.

4. The method as claimed in claim 3, wherein the material for the ring-shaped elevation has reflective properties.

5. The method as claimed in claim 3, wherein in a2) the ring is applied by one of:
mold casting; and
dispensing.

6. The method as claimed in claim 1,
wherein in that in b) the material admixed with phosphor is introduced into the first ring-shaped elevation by one of:
dispensing; and
printing.

7. The method as claimed in claim 1, further comprising:
d) providing at least one second or further ring-shaped elevation on the topmost layer admixed with phosphor;
e) introducing a material admixed with phosphor and having a second or further predefinable viscosity into the second or further ring-shaped elevation;
f) curing the material admixed with phosphor in order to produce a second or further layer admixed with phosphorist.

8. The method as claimed in claim 1, further comprising:
g) applying a protective layer to the topmost layer admixed with phosphor.

9. The method as claimed in claim 8, wherein in g) the protective layer is applied by one of:
dispensing; and
printing.

10. The method as claimed in claim 8, wherein the protective layer congruently covers the combination of topmost ring-shaped elevation and topmost layer admixed with phosphor.

11. The method as claimed in claim 1, wherein the respective ring-shaped elevation is one of circular, oval, angular and elliptical.

12. The method as claimed in claim 1, wherein at least one of the base layer, the protective layer, and the ring-shaped elevation comprise(s) one or more of the following materials:
silicone;
parylene;
epoxy resin;
glass;
polycarbonate;
polyacrylic.

13. The method as claimed in claim 1, wherein the layer admixed with phosphor comprises as carrier material one or more of the following materials:
silicone;
epoxy resin;
polyacrylic;
polyacrylic-polyurethane copolymer.

14. The method as claimed in claim 1, further comprising:
h) introducing scattering materials at least one into the material admixed with phosphor and into the material from which the protective layer is formed.

15. The method as claimed in claim 1, further comprising:
i) forming a lens shape at least one of in a layer admixed with phosphor and in the protective layer.

16. The method as claimed in claim 1,
wherein the ring-shaped elevation is not admixed with phosphor.

17. The method as claimed in claim 4,
wherein the material for the ring-shaped elevation has reflective properties as a result of doping with metal particles.

18. The method as claimed in claim 6,
wherein in b) the material admixed with phosphor is introduced into the first ring-shaped elevation by screen printing.

19. The method as claimed in claim 7,
wherein the topmost layer is the first, layer.

20. The method as claimed in claim 8,
wherein in g) the protective layer is applied by screen printing.
